(19) United States
(12) Patent Application Publication
(10) Pub. No.: US 2019/0130402 A1
(43) Pub. Date: May 2, 2019

(54) Secure Sales Tax Compliance and Fraud Prevention System for Business-to-Business Transactions

(71) Applicant: ALLAGMA TECHNOLOGIES INC., Saint-Laurent (CA)

(72) Inventors: Vartkes MELKONIAN, Lorraine (CA); Pascal DJIKNAVORIAN, Saint-Laurent (CA)

(21) Appl. No.: 15/744,895

(22) PCT Filed: Mar. 31, 2016
(86) PCT No.: PCT/CA2016/050377

§ 371 Date: Oct. 2, 2018

Related U.S. Application Data
(60) Provisional application No. 62/257,320, filed on Nov. 19, 2015.
(60) Provisional application No. 62/192,193, filed on Jul. 14, 2015.

(51) Int. Cl. G06Q 20/40

(52) U.S. Cl. CPC G06Q 20/4016; G06Q 20/4014

(57) ABSTRACT

A computer system authenticates parties to a purchase transaction and determines whether sales tax normally collectable can be exempt. An electronic tax exemption or tax-neutral authorization can be provided. The transaction data can be stored and retrieved for businesses to audit their tax-neutral sales and/or purchases. The system reduces the burden of sales tax management and improve tax compliance.

This application claims priority of U.S. provisional patent applications 62/192,193 filed Jul. 14, 2015 and 62/257,320 filed Nov. 19, 2015.

### FIELD OF THE INVENTION

The following invention is related to preventing and/or reducing sales tax crimes and fraud and also to minimizing the sales tax compliancy burden.

### BACKGROUND OF THE INVENTION

Various jurisdictions or tax authorities around the world implement a sales tax system based on specific rules established by the Tax Authority (TA). Such jurisdictions can be at a country or federal level, sub-national level (e.g. provinces or states) or at even lower levels of government (e.g. municipal, city or county). It could also be envisaged that a supranational authority (like the European Common Community) could also levy such a tax.

Regardless of the name given to such taxes, the most prevalent mechanism of levying such sales taxes is based on the principle of the Value Added Tax (VAT) or Goods & Services Tax (GST)—hereinafter referred to as VAT, where goods and/or services purchased by the consumers are taxed at varying rates based on the rules established by the TA.

It is important to note that according to the principle of the VAT mechanism, only sales to consumers are taxed. VAT mechanisms remain zero-rated for Business-to-Business (B2B) sales. To enable the desired result, various TAs around the world have implemented the concept of Input Tax Credits (ITC) where B2B transactions are taxed, but, at specific periods, businesses submit reports on the total amounts of sales taxes paid on their purchases and sales taxes collected on sales, and either remit to or collect from the TA the net difference between the two.

Over the past decades, these sales tax collection mechanisms have led to several serious problems that to date remain unsolved.

Firstly, businesses incur huge amounts of costs to manage these systems of tax collection on behalf of the TAs, which is an activity that does not contribute to their bottom line. Not only do they incur these costs, they also incur huge risks and liabilities for penalties, legal prosecution by the TA, and loss of goodwill.

It is, for example, estimated that in Canada alone, the business sector spends an annual aggregate of $7B to comply with the sales tax collection mechanism. The cost to the Canadian TAs to manage such compliance is at least half that amount (The total annual cost to the economy to manage such compliance being in the range of $10B). The invention significantly reduces this cost and may even eliminate it totally adding significant productivity gains to an economy under the jurisdiction of the TA.

Secondly, current mechanisms facilitate fraudulent behavior by businesses to engage in the claiming of illegal tax credits, through the use of various schemes. Such schemes are known to the experts in the field, and include, but are not limited to, the creation of false invoices, to setting up of fake companies as suppliers, offshore subsidiary schemes, temporary creation and shutting down of false invoice supplying businesses, etc.

While there are no complete studies that allow estimating the total economic impact of such large-scale fraud, when sensational cases come to light, they are publicized through the media.

The amounts involved in each case range in the millions, hundreds of millions and even billions of dollars in frauds. If implemented across a specific economy in any jurisdiction, the invention will completely eliminate the ITC fraud in that jurisdiction.

Thirdly, a specific type of business tax fraud is known as Electronic Sales Suppression (ESS), where businesses use various technological schemes, based on either hardware or software, to reduce the amount of the sales made in the various systems that they use. Such sales suppression can mask sales made to businesses and/or made to consumers. Over the past few years, TAs has started to combat ESS using specific tools targeted for specific industries. The most important category of such tool remain the analytical information systems at the disposal of the TAs, that, in case of suspicion of fraud, may be deployed in various audit cycles to prove such occurrence of fraud. However, said analytical systems remain limited because they maintain only aggregate information about the business in question (e.g. history of annual sales, history of annual expenses, known expense categories, industry average ratios etc.). The invention significantly enhances the analytical capability of the TAs, because it records transaction level information at any desired level of detail. Such information can then be deployed at audit cycle time and will significantly increase the ability to stop said fraud.

The deliberate falsification of sales and tax transaction records by businesses is a known problem. Although it is illegal to engage in such practices, many businesses continue to evade the sales tax (hereinafter referred to also as “tax”). In addition to the deliberate falsification, there is also the case of unintended accounting mistakes.

The corresponding loss in tax revenue for governments undermines the jurisdictions' fiscal capacities. To improve tax collection and increase revenues, tax authorities usually adopt a combination of enhanced administration, improved audits and simplified tax reporting, and collection processes to better detect or dissuade businesses from engaging in underground economic activity.

The main objective of tax laws is to ensure a steady income stream for governments. But there are always tax gaps in the economic system and governments lose billions of dollars annually because of the non-compliance. There is a method currently used by many member countries of the Organization for Economic Co-operation and Development (OECD) to estimate the tax gap. This method is based on the difference between assessed income and actual reported income.

According to the Internal Revenue Service (IRS) of the United States of America (USA), the total amount of the tax gap in the USA, in taxation year 2006, was approximately 385 billion dollars, which translates to a rate of 85.5% of compliance. For the same year in the European Union (EU), the total tax gap for the Value-Added Tax (VAT) alone was nearly 200 billion Euros.

In their 2013 Action Plan, the OECD recognized the importance of addressing the digital economy, which has loopholes that allow profits to go untaxed. The invention addresses many of these issues.

A VAT is typically a tax system in which sellers collect sales tax at a rate for a class of goods or services at every transaction, and the VAT paid by businesses for their operations can be deducted from the tax they remit to tax authorities or otherwise refunded. A VAT system effectively collects tax from consumers while impeding business-to-business (B2B) transactions that go into a business-to-consumer (B2C) sale. However, a VAT system imposes a financial and administrative burden on businesses that conduct B2B sales of collecting and remitting funds to tax authorities that ultimately will be refunded.

Periodically, businesses are required to submit reports of their sales revenues and business expenditures, from which taxes owing are calculated using an input/output tax method. Subsequently, businesses remit to or claim from the tax authority the owed amounts.

This input/output tax method causes administrative, financial and fiscal burden to businesses and creates the opportunity to submit false reports based on fake invoices to reduce the tax amounts to be remitted or to claim false credits.

Currently, different governments have different strategies to prevent fraud and minimize their tax gap. In the USA and Canada, the federal governments employ many auditors whose job is to audit and enforce proper reporting of sales tax transactions. These auditors have to visit business premises and physically verify the company's books and records for tax compliancy.

All prior art related to the field of the invention addresses only the business-to-consumer (B2C) economy. This invention is primarily designed to prevent and reduce tax fraud in the business-to-business (B2B) economy while minimizing the tax compliancy burden of businesses.

### SUMMARY OF THE INVENTION

The above-described problems of collection of sales tax by the seller for remittance to tax authorities for every sale, whether B2B or B2C, and of tax avoidance can be solved by effective use of computer systems. In the absence of the ability to determine effectively at a point of sale whether the recipient of goods or services is a business or a consumer, it makes good sense to impose the burden on the seller to charge and to collect the sales tax, and then to let the recipient make a corresponding claim that can be validated by the tax authorities. Such systems suit non-computerized transactions very well.

However, the implementation of a computerized system and network connectivity between buyers, seller and/or tax-related authorities can provide the tools for an effective determination whether a transaction should proceed at a full consumer sales tax rate or with tax exemption. Unfortunately, pre-existing computer and network systems do not have the components/configurations required to perform the necessary communications and computations to perform on a transaction basis determination of tax exemption, authentication of tax-exempt transactions and/or recordation of such transaction in such a way as to enable conformity with tax laws.

In the following, various computerized systems and methods are described to resolve, at least in part, the afore-mentioned problems.

A computer system can authenticate parties to a purchase transaction and determines whether sales tax normally collectable can be exempt. An electronic tax exemption or tax-neutral authorization can be provided. The transaction data can be stored and retrieved for businesses to audit their tax-neutral sales and/or purchases. The system reduces the burden of sales tax management and improve tax compliance.

For example, the invention is a computerized system and method that is comprised of, or related to, but not limited to, three main modules:
1. B2B Identification and Zero-Rate Tax Authorization System;
2. Transaction Logging System;
3. Transaction Retrieving System

These modules can be designed for all types of businesses, (virtual or physical, online or brick-and-mortar). The invention, hereinafter referred to as the Tax Fraud Prevention System

(TFPS), is related to preventing tax fraud and also minimizing the tax compliancy burden for businesses. The TFPS includes a B2B Identification and Zero-Rate Tax Authorization System (BIAS), a Transaction Logging System (TLS) and a Transaction Retrieving System (TRS), intended to provide tax authorities additional tools to enforce and to effectively combat tax fraud.

B2B Identification and Zero-Rate Tax Authorization System (BIAS)

In VAT systems, hereinafter known as either sales tax or tax, sales transactions between businesses typically produce an effective sales tax rate of zero percent in order to prevent double taxation. However, since the system relies on an Input-output Tax Credit (ITC) method, businesses have to periodically declare and claim the difference between collected and paid sales taxes. This ITC method opens the door for many types of errors in tax declarations and willful fraud.

The BIAS identifies the buyer and/or seller as being a business and then authorizes the transaction as being eligible for a Zero-Rate tax. In some tax jurisdictions certain type of individuals are recognized to be exempted from paying sales tax altogether. An example of such individuals might be, but not limited to, a diplomat or native/aboriginal, hereinafter recognized, treated and processed as a business. This will eliminate the need for businesses to collect or pay any sales tax on B2B transactions.

Hereinafter, we use the expressions zero-rated, zero rate, and neutral, interchangeably to express a transaction with no sales tax.

A preferred embodiment of business identification uses digital verification against available databases; alternate embodiments could use any method of identification in the art.

The BIAS is designed to identify and confirm that both parties are legitimate active businesses, in order to zero-rate the taxes of the transaction. In the case of an import or export transaction where one party cannot be served by the invention, then the other party must be legitimate and active. The identification of businesses is done using a preset secured database approved and updated by the tax authority that can be securely accessed locally or remotely.

The input to the BIAS can include, for example, the Business Identification Numbers (BINs) of the buyer and the seller.

The BIAS process is as follows:
1. The BINs of both or one party are confirmed as being legitimate and active;
2. An authorization code, or other token, can be generated, which permits a transaction with zero-rate tax;
3. The authorization code, the BINs and date/time stamp can be recorded in a secure database, locally or remotely, preferably along with other data to identify the transaction, such as the transaction amount, a description of the goods or services, etc.

Transaction Logging System (TLS)

Some businesses do not record and report their actual revenues and expenses, either intentionally or unintentionally. This leads to improper tax credit claims from tax authorities, which is also considered to be fraud. This is known in the art as Input Tax Credit (ITC) fraud.

The TLS can record each authorized transaction with the taxes having been zero-rated (with further details that are deemed important by the tax authority) for auditing purposes. This process can use a secure communication link, either in real-time or in periodic batch transfers.

The system can be comprised of at least two databases to record the transactions. The databases will record all the transactions both locally and remotely to ensure the accuracy, consistency and the integrity of the recorded data. The remote recording may or may not be administered and supervised by tax authorities.

Transaction Retrieving System (TRS)

At anytime a business, either a seller or a buyer can retrieve aggregate information about their tax declaration from the Tax Authorities. The retrieved information may be used for any business purpose. For example, to validate declared tax amounts or to make adjustments to previously declared amounts.

The TRS can retrieve the transaction information previously logged by the TLS and make it available to the requesting owner. This information can be retrieved in the form of an individual transaction, a list of transactions or aggregate information for the current or historical periods.

The Objectives and Benefits of the Invention

The intended outcome of pre-authorizing and registering zero-rated tax for B2B transactions, using the invention, include but are not limited to the following:
1. Primary objective:
   a. To prevent, or reduce, tax frauds;
2. Secondary Objective:
   a. To simplify the periodic tax declarations;
   b. To relieve businesses of the burden of administering sales taxes and related liabilities;
   c. To reduce the administrative and auditing overhead of tax authorities;
   d. To let businesses validate the authenticity of all their B2B transactions.

About the Invention

In some embodiments there is provided a tax compliance system for use within a taxation system in which business-to-business transactions can be tax neutral while business-to-consumer transactions can be taxable. “Business-to-business” is an expression that corresponds to reduced tax or zero-tax transactions and can include parties that are tax exempt for reasons other than being a business, such as charitable organizations, indigenous peoples, diplomats, etc.

The computer system can be comprised of subsystems that can be part of the same server system or distributed as desired. These subsystems are as follows. A first subsystem is configured to collect transaction data representing a transaction between a buyer and a seller of goods or services, the transaction data including an identification of the buyer, an identification of the seller, an identification of transaction, and a transaction amount. This can involve a web server that allows the seller or the buyer to specify the information using a browser, and in some cases this is practical, or this can involve data transmission coming from a point of sale terminal or an online sales transaction server that does not involve the buyer or the seller directly interfacing with the first subsystem. It will be appreciated that this can provide a digital interface for receiving digital transaction data representing a transaction between a buyer and a seller of goods or services and a digital confirmation message from the buyer, such that the first subsystem is in communication with this interface. It will also be appreciated that the first subsystem can be configured to store the transaction data in a computer-readable storage memory.

A second subsystem is configured to receive input from the buyer to confirm eligibility for a tax neutral business-to-business transaction with the seller concluding the transaction with no tax collection.

The eligibility for the tax neutral business to business transaction is determined by either one or both of a processor configured to authenticate a tax authority issued identification certificate of the buyer as received from the buyer to ensure genuine involvement of the buyer in the transaction and to confirm that the buyer is genuinely a business and not a consumer, and a processor configured to deliver, over a communication link to an electronic account associated with the buyer according to tax authority records, information concerning the transaction, and to receive from the buyer an indication if the transaction is not an actual transaction between the buyer from the seller.

This second subsystem can be fully integrated with the first subsystem or it can be distinct. For example, a web page that allows a buyer to log into her account associated with her business identification number (BIN) and specify the seller (by BIN or other identification) along with the transaction details, for example an invoice number and amount, could be used to provide the buyer with an authorization code that the buyer could use in paying the invoice, without paying the tax.

In such a system, the transaction data can be provided, either by direct operator input using a suitable interface, such as a web browser interface, or by interfacing with a point of sale or online transaction system, by the buyer, or by the seller, or jointly by participation of both the buyer and the seller.

In an otherwise paper-based transaction, for example, this could mean that the buyer, who received an invoice for an amount including sale tax, pays the invoice by mailing a check for the amount before sales tax with a reference to the authorization code obtained from the second subsystem. The seller can then accept payment of the invoice using the amount of the check (or bank transfer payment) before sales tax and consider the sales tax paid or accounted for by relying on the authorization code. The seller can optionally validate the authorization code before relying on it.

A third subsystem is configured to receive data from the second subsystem and, in response thereto, to provide for the seller either one or both of a tax exemption authorization message for the purposes of providing authorization for the transaction to take place without tax collection, and a message or a report to inform said seller whether the transaction requires tax collection. It will be appreciated that the third subsystem can be in digital communication with the second subsystem, and that it can initiate a digital transmission to a computing entity associated with the seller.

The seller's acceptance of payment of the pre-tax amount for the transaction can involve the computer network to verify that the transaction is authorized for a tax neutral or tax reduced transaction, or the seller can rely on the authorization code alone without computer network based verification. The computer network based verification can involve a query that the authorization code is valid, or it can involve a retrieval of the transaction data recorded using the authorization code as a record locator and then to confirm that the transaction is properly recorded.

Alternatively, in the case that the buyer is solely responsible for recording the transaction data in the computer system that gives, for example, an identification of the buyer, the seller and the transaction amount, the seller may simply check a transaction records data store to locate if a transaction between the seller and the buyer has been recorded and if such is the case, proceed with the transaction without tax.

The seller can perform this check using a web interface or it can be an automated check implemented in a point of sale or an online sales transaction system. The seller has the assurance that the buyer is eligible for the tax-neutral or tax reduced transaction, because the computer system requires the buyer to be authenticated to record the transaction. In this case, the authorization code that allows the seller to proceed with the zero tax transaction is the response from the transaction record store that confirms the presence of the transaction, instead of a code sent to the seller from the system or the buyer.

The transaction record store can also record that the seller has recognized the transaction as valid. This data can be used to provide to any business a list of transactions that includes only those transactions that both the buyer and the seller have confirmed or that are otherwise deemed validated.

When a seller is about to proceed with a zero-tax transaction and checks the data store to confirm that the transaction between the buyer and the seller is valid, a failure to confirm results in the seller requiring sales tax collection. In the case that the sale was already concluded without collecting tax, the seller would then proceed with collecting tax from the buyer.

When the buyer enters the transaction information and obtains the authorization code, the transaction data can be recorded in a server that the buyer can use to see a list of transactions recorded in association with her account for auditing purposes. Additionally, in some embodiments, the seller can also obtain from the transaction records in the database a listing of sales transactions attributed to the seller.

While a seller can benefit from communication with a transaction record data store to confirm that a transaction should proceed without tax collection, when a tax exemption authorization message provides sufficient confidence of authorization for the transaction to take place without tax collection, it is optional to provide the seller with access to a listing of transactions or information concerning validated transaction. Sufficient confidence of authorization can be provided, for example, by trusted confirmation, such as data encrypted using recognized encryption keys.

Other features and aspects of various embodiments are also defined in the appended claims.

### Definitions

The following defines some of the terminology used in this patent application:
“Transaction Amount” refers to the monetary value of a transaction before any sales taxes are applied. It is also known as “sub-total”.
“Tax Amount” refers to the monetary value of the sales tax for one, or more, transaction.
“Tax Authority”, is the entity authorized to act on behalf of a government to manage and collect taxes.

### DESCRIPTIONS OF THE FIGURES

The accompanying drawings further describe the invention.

FIG. 1 illustrates an embodiment of the structural schematics, describing the prior art for B2B sales transactions.

FIG. 2 illustrates an embodiment of the structural schematics of the invention TFPS.

FIG. 3 illustrates an embodiment of the structural schematics of the invention for B2B sales transactions.

FIG. 4 illustrates an embodiment of the process flow of prior art for B2B sales transactions.

FIG. 5 illustrates an embodiment of the process flow of the invention for B2B sales transactions where tax authorities of both the buyer and seller have adopted the use of the invention.

FIG. 6 illustrates an embodiment of the process flow of the invention for B2B sales transactions when the seller is exporting or the buyer is importing.

FIG. 7 illustrates an embodiment of the process flow of the invention for B2B sales transaction where a Purchase Order (PO) is not submitted to the seller or the seller is exporting.

FIG. 8 illustrates an embodiment of the process flow of the invention for B2B sales transactions where the Zero-Rate authorization does not require validation of the BIN.

FIG. 9 illustrates an embodiment of the tax filing process flow after ITC has been eliminated by the use of the invention.

FIG. 10 illustrates an example of a periodic sales tax declaration form that could be used within a tax jurisdiction that is using certain embodiments of the invention.

FIG. 11 illustrates an embodiment of the process flow of the invention for B2B sales transactions where the buyer can, through the TFPS, confirm ownership of a transaction as recorded by the Tax Authority.

### DETAILED DESCRIPTION OF THE INVENTION

The five-digit (#####) numeric system used in all figures represents the following structure:
1####—A non-invention structural element
   110##—A structural element of the Financial System
   180##—A structural element of the Tax Authority
   190##—A structural element of communications
2####—A non-invention process element
   210##—A process element of the Buyer
   220##—A process element of the Seller
   280##—A process element of the Tax Authority
3####—An invention (TFPS) element
   31###—An element of the invention, TFPS client
      311##—An element of the BIAS, on the client side
      312##—An element of the TLS, on the client side
      313##—An element of the TRS, on the client side
   32###—An element of the invention, TFPS server
      321##—An element of the BIAS, on the server side
      322##—An element of the TLS, on the server side
      323##—An element of the TRS, on the server side

The present description provides detailed information about transaction methods to be implemented using a variety of computer system infrastructure platforms. It will be appreciated that such methods are made possible by programming or otherwise configuring such computer systems to perform the methods and processes described herein. Such programming and configuration will be readily apparent to a person skilled in the art following the detailed description of the methods and process steps provided herein.

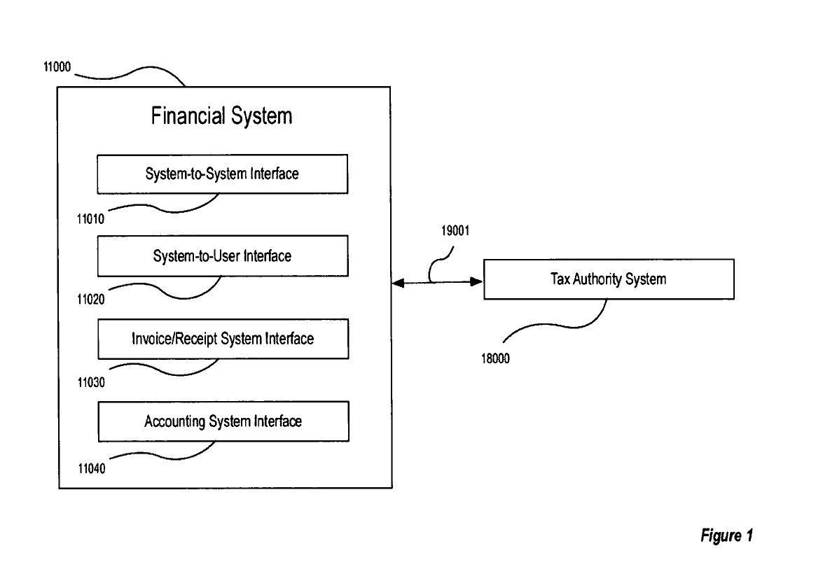

FIG. 1 Illustrates an Embodiment of the Structural Schematics Describing the Prior Art for B2B Sales Transactions.

The modules illustrated in the Figures can be implemented separately or in an integrated manner in software executed on a single computer platform or on different computer platforms at each desired location within the networked implementations of the various embodiments. While the manner of coding or processing the data to perform the functions described herein with reference to the blocks or modules can vary significantly without impact on the fundamental operation of the embodiments, it will be appreciated that the combined software and hardware implementation is responsible for the proper operation of the system or methods described herein.

The Financial System [11000] can be: a mobile device performing sales or purchase transactions; a billing and/or invoicing system; a Point-of-Sale system; an e-commerce system; an accounting system or any other system for processing a sales and/or purchase transaction. Said Financial System [11000] is generally comprised of four (4) components: a system-to-system interface [11010], a system-to-user interface [11020], an invoice/receipt system interface [11030], and an accounting system interface [11040].
1. The system-to-system interface [11010] is a component of any financial system that interfaces with various parts of the Financial System [11000] or other external systems. For example, an operating system is in charge of interfacing between a hardware device and an application and could be considered a system-to-system interface.
2. The system-to-user interface [11020] is a component of any financial system that interfaces between an individual that is using the said Financial System [11000]. For example, a touch screen of a Point-of-Sale device could be considered a system-to-user interface.
3. The invoice/receipt system interface [11030] is a component of any financial system that interfaces with any component that relates to the bill/invoice or the receipt production. For example, a financial system printer and printer drivers can be considered an invoice/receipt system interface.
4. The accounting system interface [11040] is a component of any financial system that interfaces with any type of accounting system. For example, a financial system could use an Application Programming Interface (API) designed to communicate with an accounting system to produce quarterly reports.

The Financial System [11000] uses any type of online, offline, or manual, communication method [19001] accepted by the tax authority, to communicate with the Tax Authority System [18000]. Conventionally, the Accounting System Interface [11040] generates a display for an accountant or financial officer of the business of an amount of sales tax to be remitted to one or more tax authorities, and payment is made by instruction of the accountant of financial officer using conventional payment mechanisms, such as a mailed bank check or bank wire transfer.

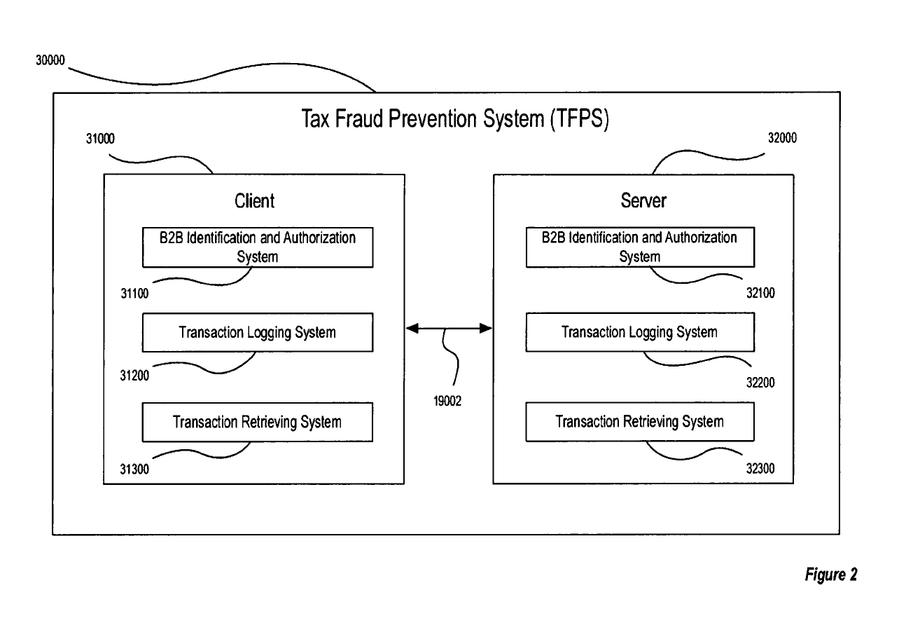

FIG. 2 Illustrates an Embodiment of the Structural Schematics of the Invention TFPS.

In this embodiment, the TFPS [30000] is designed as a multitier, client [31000] and server [32000], application architecture. It can be made of platform-independent software code. It can be designed to allow third party software/hardware to communicate with it using Application Programming Interface (API) modules and/or Software Development Kit (SDK).

TFPS Client [31000] can be either:
1. Embedded within the Financial System [11000];
2. Integrated with the Financial System [11000] as an external module in the form of:
   a. An external independent hardware (Operating System [OS] independent with firmware);
   b. A connected system (OS dependent).

TFPS Server [32000] can be:
1. Configured as a specific server on a networked-architecture of clustered server farm systems (also known in the art as a cloud infrastructure);
2. Located at any data center approved by tax authorities;
3. Managed by any licensed service provider authorized by tax authorities.

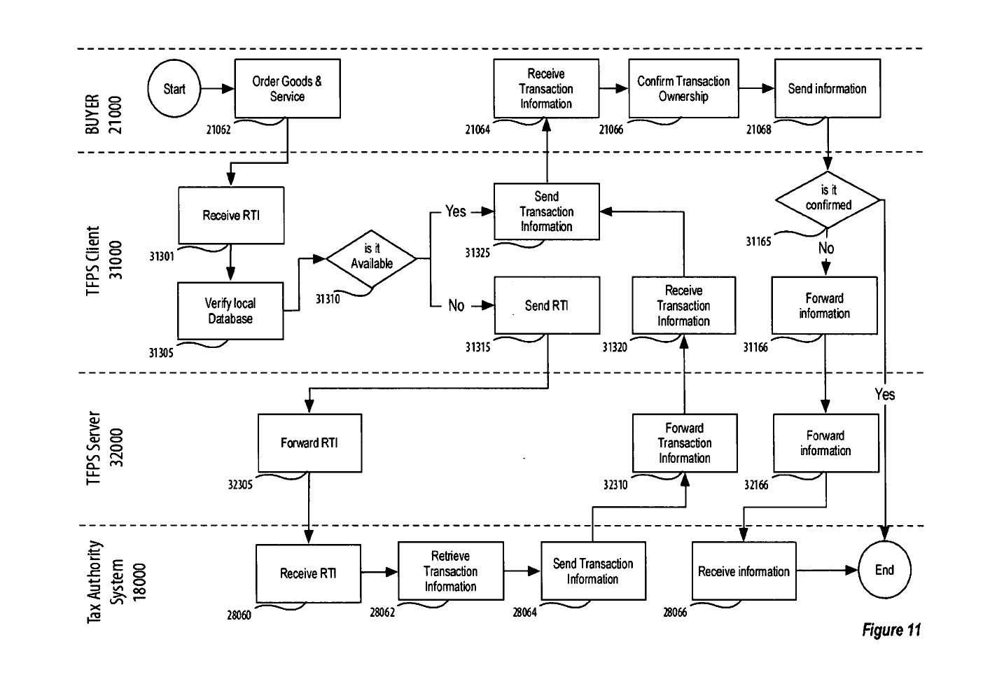

The preferred embodiment of both the TFPS Client [31000] and TFPS Server [32000] has three main components: the BIAS [31100] and [32100], the Transaction Logging System [31200] and [32200] and the Transaction Retrieving System [31300] and [32300].
1. The BIAS [31100] and [32100] are components that authorize a zero-rated tax transaction and then generate an authorization code, after confirming that one or both businesses are legitimate and active. The system's validation of the businesses can be based on a Business Identification Number (BIN).
   a. The BIN is a unique identifier that is provided by tax authorities (or provided by a company registry and recognized by tax authorities), which could be an existing business/tax registration number or a number that is issued specifically for TFPS use.
   b. In various embodiments, the buyer's BIN could be obtained by the seller, through some of, but not limited to, the following means, which may or not have any type of security measure as known in the prior art:
      ID card, Credit Card, Digital dongles, Electronic keys, and any other identification mechanism that is approved by tax authorities; or
      access to a company registry or the like to find the BIN of the buyer based on the buyer's business name as given verbally or as printed on or recorded in an ID card or credit/debit card.
   c. In some embodiments, the BIAS can operate and generate an authorization code without receiving confirmation that one or both businesses are legitimate and active. A confirmation step can occur at a later stage as exemplified in FIG. 11.

In various embodiments, each transaction is authenticated by either the BIAS [31100] or [32100], but not both.
1. In the preferred embodiment of the BIAS [31100], the seller is required to provide both the seller's and buyer's BIN to the TFPS [30000].
2. An alternate embodiment of the BIAS [32100] would allow the buyer to enter both required BINs on behalf of seller to the TFPS [30000].
3. Alternate embodiments of the BIAS [31100] and [32100] would allow the buyer and the seller to each enter their own BINs for authentication purposes, using any type of secure interface, to either the TFPS Client [31000] or [32000] respectively.
4. In all embodiments of the BIAS [30100] and for each transaction, the identity of the buyer and/or the seller may be authenticated using either a uni-factor or multi-factor authentication system as known in the prior art.

The TLS [31200] records the transactional data along with the zero-rated tax authorization code in a database within the system [31000]. TFPS Server [32000] retrieves or receives the data from [31000] and after checking the integrity of the data, records it into a database managed by the Tax Authority System [18000]. Alternatively the authorization code can be generated by the server [32000] and then shared with the client [31000].

In all embodiments of the TFPS Server [32000], all the recorded data can be available to both the buyer and the seller at any time after the transaction is completed, for the purposes of security, validation, sales/purchases reconciliation, and any financial or business reasons.
1. In most embodiments, both TLS [31200] and [32200] record the following transaction information known as Base Data in full or in part and in any order:
   a. a zero-rated tax authentication number;
   b. one or both of the seller and the buyer BINs;
   c. the date/time stamp of the transaction;
   d. the sales transaction identification (bill/invoice/receipt number), provided either by the seller or buyer;
   e. the transaction amount, provided either by the seller or buyer.
   f. the Zero-Rated tax value, provided either by the seller or buyer.
2. In an alternate embodiment, both TLS [31200] and [32200] can record other transactional information, which contains detailed item level information, such as pricing and quantity sold, in addition to the Base Data.

In an alternate embodiment of the invention, the buyer can log into any embodiment of the TFPS to supply invoice information, including the value of the transaction and the seller identification, to obtain an authorization code to zero-rate the tax for said transaction. The buyer then will have the opportunity to only pay the value of the transaction without sales tax as the buyer or the TFPS will supply the seller with said authorization code at a later time.

The buyer or the seller can interface with the TFPS by way of interfaces between their accounting systems, online sales transaction systems or point of sale transaction systems, or alternatively using browser or app interfaces that involve user input. The latter can be useful to allow the TFPS to be used by smaller businesses or businesses that only occasionally sell to other businesses.

The seller in turn
a) Can log into any embodiment of the TFPS to confirm the validity of the said authorization code and proceed with the sale transaction with zero-rated sales tax;
b) Can proceed with the sale transaction with zero-rated sales tax and validate the authenticity of the transaction at a later stage as exemplified by the process of FIG. 11.

In all embodiments of the TFPS Server [32000], all the recorded data can be available to both the buyer and the seller at any time after the transaction is completed, using the TRS [31300] and [32300] for the purposes of security, validation, sales/purchases reconciliation, and any financial or business reasons.
1. In all embodiments, both TRS [31300] and [32300] can retrieve the information known as the Base Data as described above.
2. In an alternate embodiment, both TRS [31300] and [32300] can retrieve other transactional information, which contains detailed item level information, such as pricing and quantity sold, in addition to the Base Data.

In alternate embodiments the invention can have a financial institution act as a third party that will manage the sales tax collection and/or tax remittance and/or tax exemptions for the business directly at the Point-of-Sale (whether in a physical store or online). In such embodiments, the identification of a buyer as a business will be made with the use of the provided payment method by the financial institution of the buyer that involves identification and authentication of the buyer for payment purposes. For example, at the moment of the transaction, the payment infrastructure can be modified to include a prompt for a confirmation from the buyer to confirm that the purchase is for the Business (rather than a taxable consumer purchase) linked to the financial account.
In the case of a purchase made using a credit/debit card through a point of sale terminal or online transaction server, a conventional transaction involves the merchant's system sending a request for payment to the financial institution payment system that includes an amount. In the case of a point-of-sale terminal, the cardholder is requested to confirm the purchase for the amount, and provide authorization, in some cases using a PIN entry. The payment system conventionally processes only the grand total amount of the sales.
This system can be modified so that the merchant's system sends a pre-tax subtotal amount as well as the tax amounts to the payment system. In this modified system, the financial institution has the total amount and the sales taxes separately. The financial institution can also have access the cardholder's business identification, from the card or from financial institution records, for example.
It is possible in such an infrastructure to transfer the responsibility of tax remittance when sales tax is payable from the merchant to the financial institution itself or the payment system service. The merchant can collect the pre-tax subtotal amount less any service fees. The merchant can determine if the buyer qualifies for a tax neutral transaction and decide whether tax needs to be collected or not. This can include an interaction with the buyer to confirm that the purchase is for business purposes and not an otherwise taxable purpose, for example by gathering input using a point-of-sale terminal or input through a user interface such as a browser or mobile computer device. This decision can also be communicated from the payment service system to the merchant system for the purposes of recording and reporting to the buyer what sales taxes were paid or exempted.
The financial institution can use any method it currently accepts to confirm ownership of the financial payment method to confirm the legitimacy of the use of the card by the buyer. For example, a purchaser can use a credit or a debit card of the business, and confirm his legitimacy of use of the card with a PIN, provided by the financial institution, related to the card.
In another example, the purchaser could receive a text message on his mobile communication device, which would require a response to provide said confirmation. In another example, a contactless payment method can be used, provided that the buyer respects contactless payments conditions of the financial institution, in which case the buyer can make post-transaction confirmation. Because the payment service can remit the sales tax when applicable, it is possible for the sale to conclude with tax appearing as collected, only to then be credited should the tax be deemed to be exempted, or the sale can take place with no tax paid, and then be charged to the buyer's financial institution account if the exemption is not confirmed. A confirmation of ownership of transactions by a business post-transaction is exemplified in FIG. 11 herein below.
While in the example above, the financial institution or payment service handles remittance of sales tax, it will be appreciated that it is possible to leverage the modified infrastructure of the financial institution or payment service while leaving the merchant responsible to remit any sales tax due.
The BIAS would then use the financial institution confirmation, as a binding confirmation, that the buyer is indeed representing the identified business and that the purchase in progress is made for said business. Further validation of the ownership of the transactions by the business at the periodical validation time can be made in embodiments where such further validation post-transactions are required.
Such embodiment can be of particular interest where financial institutions already have payment processing equipment, hardware and/or software, in place at merchants' point-of-sale. It would also be beneficial where it is not already implemented as financial institutions have payment processing infrastructure kit easily setup.

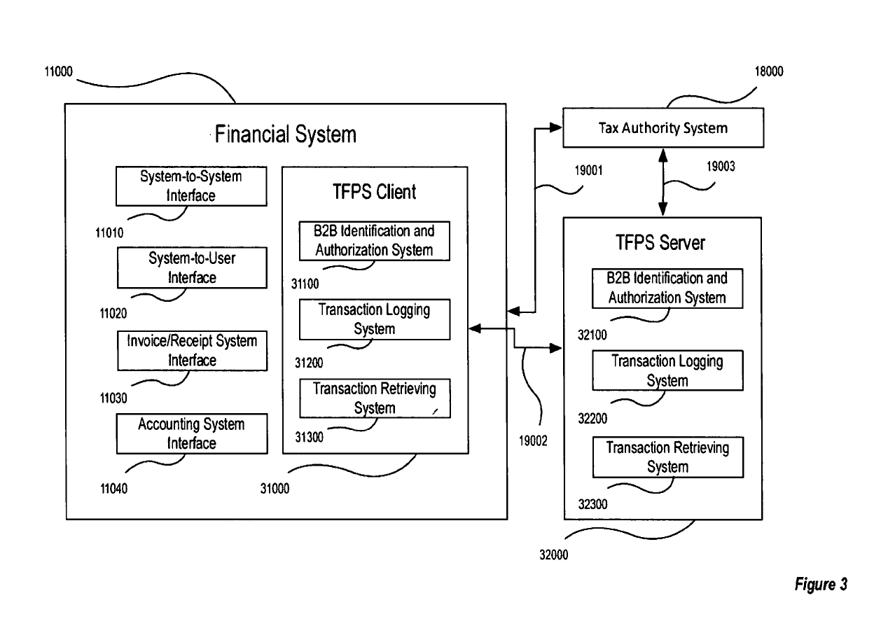

FIG. 3 Illustrates an Embodiment of the Structural Schematics of the Invention for B2B Sales Transactions.

The TFPS Client [31000] can be integrated with the Financial System [11000] as follows:
1. The TFPS Client [31000] can be integrated with the Invoice/Receipt System Interface [11030] using an API or an SDK. The TFPS Client [31000] can interact with the [10130] interface to receive and update the Invoice/Receipt system with the sales transaction data and authentication of the transaction;
2. In an alternate embodiment, the TFPS Client [31000] can be integrated with the Financial System [11000] using any external connection mechanism known in the prior art.
3. In all embodiments, the TFPS Client [31000] can be interacting with an accounting system through the Accounting System Interface [11040] using any communication method known in prior art. This can allow for the buyer and the seller, to have their accounting system updated by the TFPS with the retrieved information as recorded by the TFPS.

The TFPS Client [31000] can interact with the TFPS Server [32000] as follows:
1. In the preferred embodiment, the TFPS Client [31000] can communicate with the TFPS Server [32000] to transfer transactional data in real-time;
2. In an alternate embodiment, the TFPS Client [31000] can communicate with the TFPS Server [32000] to transfer transactional data at a pre-arranged frequency approved by the tax authority.
3. In all embodiments, the TFPS Client [31000] can receive all its data updates from the TFPS Server [32000]. Such data may include, but are not limited to, system updates, application updates, authentication data, etc.

The TFPS Server [32000] can interact with the Tax Authority System [18000] as follows:
After receiving the transaction data from the TFPS Client [31000], the TFPS Server [32000] can check the integrity of the incoming data. Then, if the integrity of the data is accurate and complete, the TFPS Server [32000] can confirm it to be so and can transfer the received data to the Tax Authority System [18000] for permanent storage.

All systems using real-time electronic transmission methods over [19001], [19002], and [19003] can use secure, encrypted, data transmission protocols such as TCP or UDP or any other transmission protocol known in the art.

The Financial System [11000], the TFPS Server [32000], and the Tax Authority System [18000] can also transfer data to each other using non-real-time methods, such as an encoded message printed on paper, or any type of mobile data storage device or any other transmission protocol known in the art.

By using the server-based business identification or validation, it is possible within the framework of a business-to-business transaction to timely complete the transaction with confidence that fraud is not being committed. By giving the businesses access to the transaction data in the TLS [32200] using the TRS [32300], businesses are able to perform audits of the zero-rated B2B transactions that they are involved in, so that they are able to confirm that they are not participating in tax fraud. This allows businesses to fully trust the system for efficient, zero-rated tax transactions.

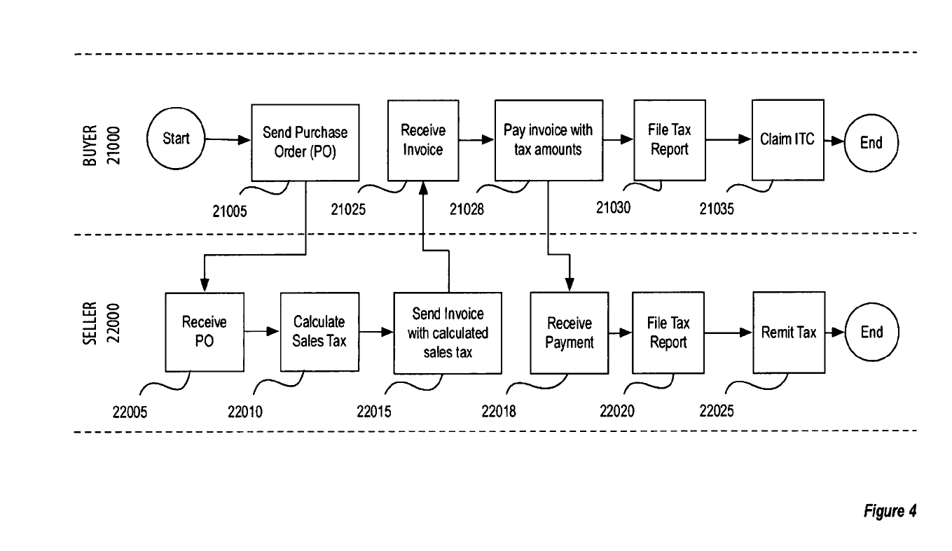

FIG. 4 Illustrates an Embodiment of the Process Flow of Prior Art for B2B Sales Transactions.

The process flow chart diagram, represented as known in the art as swim lanes, where the first lane (top row) shows processes performed by the buyer, and the second lane (bottom row) shows processes performed by the seller.

The process starts when:
the buyer will Send Purchase Order (PO) [21005] to the seller;
the seller will Receive PO [22005];
the seller will Calculate Sales Tax [22010];
the seller will Send Invoice with calculated sales tax [22015] on the sale grand total;
   the seller will Receive Payment [22028] from the buyer;
   the seller will periodically, File Tax Report [22020];
   the seller will Remit [22025] collected taxes;
the buyer will in turn Receive the Invoice [21025];
   the buyer will Pay invoice with tax amounts [21028] to the seller;
   periodically, the buyer will File Tax Report [21030];
   the buyer will Claim Input Tax Credit (ITC) [21035];
End.

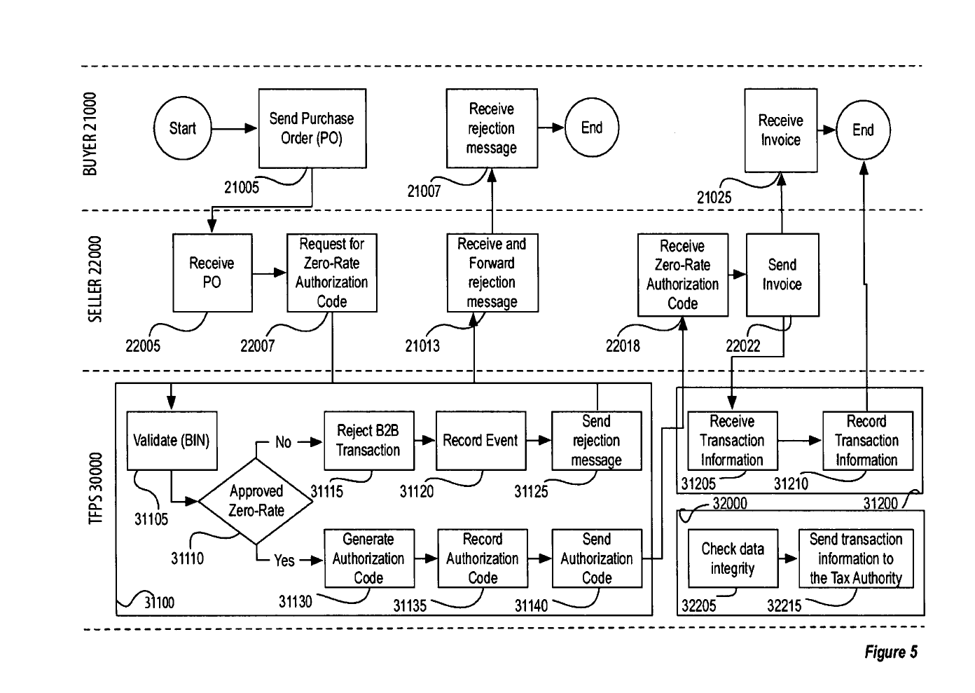

FIG. 5 illustrates an embodiment of the process flow of the invention for B2B sales transactions where tax authorities of both the buyer and seller have adopted the use of the invention.

The process starts when:
the buyer will Send PO [21005] to the seller;
the seller will Receive PO [22005];
the seller will Request for Zero-Rate Authorization Code [22007] from the BIAS [31100] of the TFPS Client [31000], and the request can contain any part, or all of, the base data;
the BIAS [31100] will Validate Business Identification Number (BIN) [31105] of both the seller and the buyer and approve the transaction;

If the BINs of either, one or both of, the seller and the buyer are NOT valid [31110]:
Reject B2B Transaction [31115];
Record Event [31120];
Send rejection message [31125] to the seller;
the seller will Receive and Forward Rejection Message [22013] to the buyer;
The process ends with the buyer Receive Rejection Message [21007].

If the BINs of both the seller and the buyer are valid [31110]:
the BIAS [31100] will Generate Zero-Rate Authorization Code [31130];
the BIAS [31100] will Record Zero-Rate Authorization Code [31135];
the BIAS [31100] will Send Zero-Rate Authorization Code [31140] to the seller;
the seller will Receive Zero-Rate Tax Authorization Code [22018];
the seller will Send the Invoice [22022] to the buyer and at the same time update the TLS Client [31200] with the final B2B transaction information.
the buyer will Receive Invoice [21025];
the TLS Client [31200] will Receive Transaction Information [31205] from the seller;
the TLS Client [31200] will Record Transaction Information [31210] in a database;
the TLS Client [31200] will update the TLS Server [32200] through the communication link [19002];
the TLS Server [32200] will Check data integrity [32205];
the TLS Server [32200] will Send Transaction Information to the Tax Authority [32215] to be stored permanently in a database of the Tax Authority System [18000];
End.

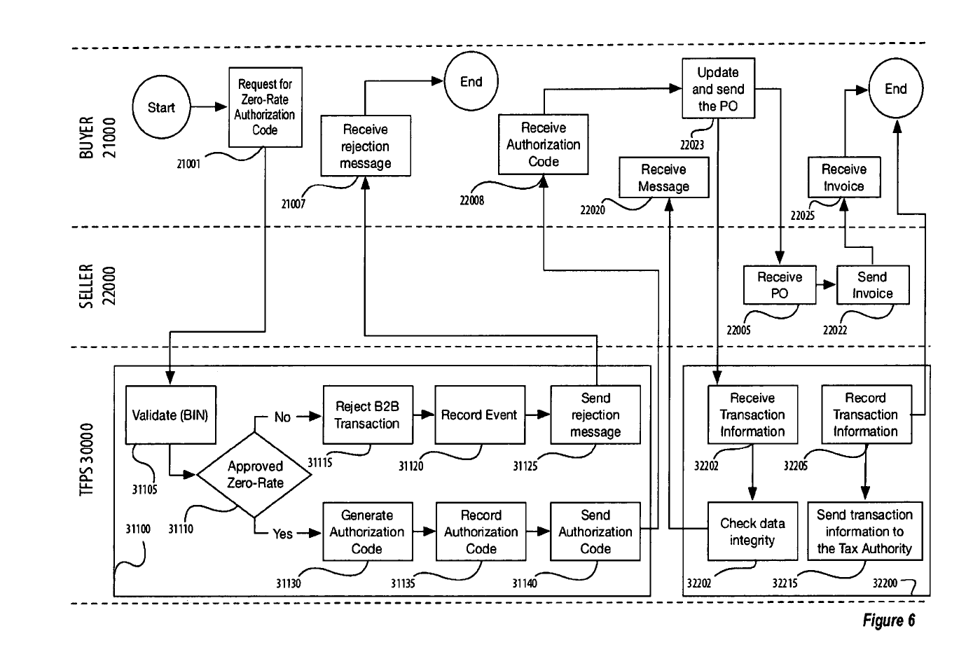

FIG. 6 Illustrates an Embodiment of the Process Flow of the Invention for B2B Sales Transactions when the Seller is Exporting or the Buyer is Importing.

The process starts when:
the buyer places a Request for Zero-Rate Authorization Code [21001] from the BIAS [32100] of the TFPS Server [32000];
the BIAS [32100] will Validate Business Identification Number (BIN) [32105] and approve the transaction;

If the BINs of either one or both of the seller and the buyer are NOT valid [32110]:
Reject B2B Transaction [32115];
Record Event [32120];
Send Rejection Message [32125] to the seller;
The process ends with the buyer Receive Rejection Message [21007].

If the BINs of both the seller and the buyer are valid [32110]:
the BIAS [32100] will Generate Zero-Rate Authorization Code [32130];
the BIAS [32100] will Record Zero-Rate Authorization Code [32135];
the BIAS [32100] will Send Zero-Rate Authorization Code [32140] to the buyer;
the buyer will Receive Zero-Rate Authorization Code [21008];
the buyer will Update and Send the PO [21023] to the seller and at the same time update the TLS server [32200] with the final B2B transaction information;
the TLS Server [32200] will Register PO Information [32201] from the buyer;
the TLS Server [32200] will Send a Confirmation of the Registration [32202] to the buyer who will receive it [21020];
the seller will Receive PO [22005];
the seller will Send Invoice [22022] to the buyer;
the buyer will Receive Invoice [21025] and will send a transaction information to the TLS Server [32200];
the TLS Server [32200] will Check data integrity [32205];
the TLS Server [32200] will Send Transaction Information to the Tax Authority [32215] to be stored permanently in a database of the Tax Authority System [18000];
End.

In another embodiment of the process described in FIG. 6, the TFPS Client [31000] of the buyer can perform the same functions of the TFPS Server [32000] of FIG. 6. The TFPS Client [31000] will then update the TFPS Server [32000] to Send Transaction Information to the Tax Authority [32215].

While it can be conventional that no tax is collected by the seller when the buyer is outside of the seller's tax jurisdiction, the TFPS can offer a number of advantages in recording such transactions. One advantage is the ability of Customs authorities to be able to recognize the B2B transaction in the TFPS and thus avoid any attempt to collect sales tax during importation. This can be facilitated by labeling the items shipped with the authorization code. A second advantage is the ability for the business to have a more complete record of inventory through the data stored in the TFPS, since essentially all B2B transactions would be recorded.

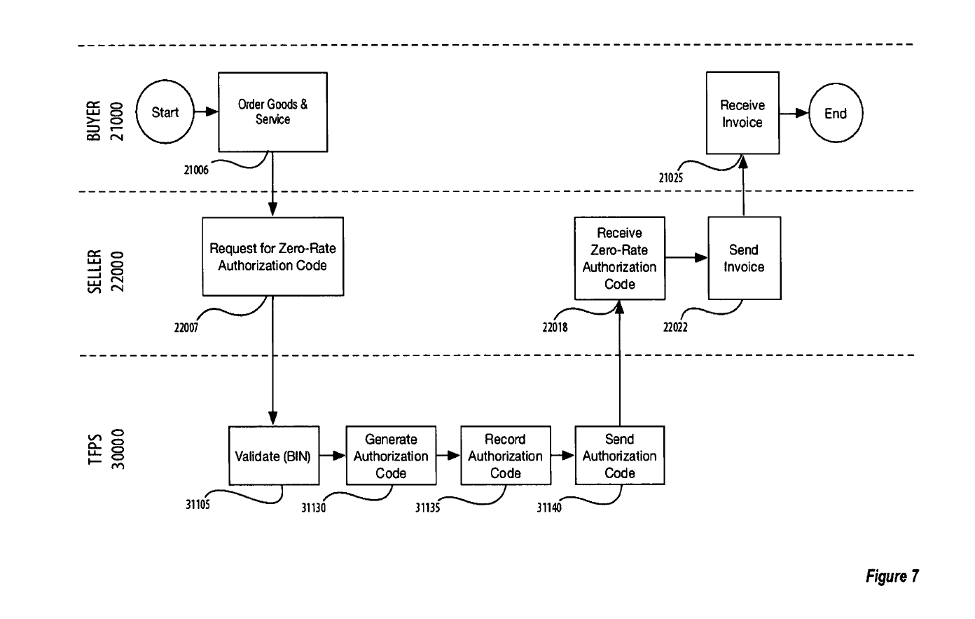

FIG. 7 Illustrates an Embodiment of the Process Flow of the Invention for B2B Sales Transaction where a Purchase Order (PO) is not Submitted to the Seller or the Seller is Exporting.

In the preferred embodiment of this process flow, the BINs are not validated electronically and the Zero-Rate Tax Authorization Code is produced upon request.

In the preferred embodiment of this process flow, the system may or may not interact with the TFPS Server [32000] to transfer the recorded data to the Tax Authority System [18000]. Said interaction may or may not be in real-time or in periodic batch transfers, using any secure communication link, using any method described in the prior art.

The process starts when:
the buyer places Order Goods & Services [21006];
the seller will Request for Zero-Rate Authorization Code [22007] from the BIAS [31100] of the TFPS Client [31000];
the BIAS [31100] will Validate Business Identification Number (BIN) [31105] for both the seller and the buyer;
the BIAS [31100] will Generate Zero-Rate Authorization Code [31130];
the BIAS [31100] will Record Transaction Information [31210];
the BIAS [31100] will Send Zero-Rate Authorization Code [31140] to the seller;
the seller will Receive Zero-Rate Authorization Code [22018];
the seller will Send the Invoice [22022];
the buyer will Receive Invoice [21025];
End.

In another embodiment of the process described in FIG. 6 or 7, the seller can log into the TFPS server using the seller's account to retrieve a code that can be given to the buyer. The buyer can then log into the TFPS using her account, for example using a secure web server, and provide the code given to her from the seller.

Alternatively, the seller could initiate the transaction in the TFPS and obtain the code for transfer to the buyer. This system allows the communication between the buyer and seller to be using a different system, such as voice, texting, e-mail or via a web server, instead of using the TFPS as the mechanism that interconnects the two parties. However, the TFPS uses the code to link the transaction data between the buyer and the seller. This means that the initiating party need not give the credentials or BIN of the other party.

When the other party uses the code to continue the transaction, the TFPS links the initiating party with the other party in the transaction to generate the zero-rate authorization code. This latter number can be sent to the seller or the buyer or both, either by using a web server where one or both parties are logged in, or a separate message could be sent. Thus, the TFPS can be the vehicle for sending the invoice [22022] to the buyer, or as illustrated, the seller can produce the invoice and send it directly to the buyer. This process can be fully electronic, or it can be done in a conventional system where the seller produces an invoice, for example as a PDF electronic document to be sent electronically to the buyer or printed on paper and delivered to the buyer. The invoice would bear the zero-rate authorization code that would give the seller and the buyer confirmation that proceeding with the zero-rate transaction is in compliance with tax regulations.

In these alternative embodiments, it is possible that the full and correct BIN identity of the parties be shared or not between the parties. This can provide for greater privacy, if desired, since only the TFPS needs to know the correct identity of the parties when the TFPS is certain that each party's credentials are valid. Not sharing the identity of the parties with each other in the transaction is a choice that can be suitable when the tax regulations permit the seller to make a zero-rate tax transaction to a party that the TFPS has validated without imposing responsibility for verifying the identity of the buyer.

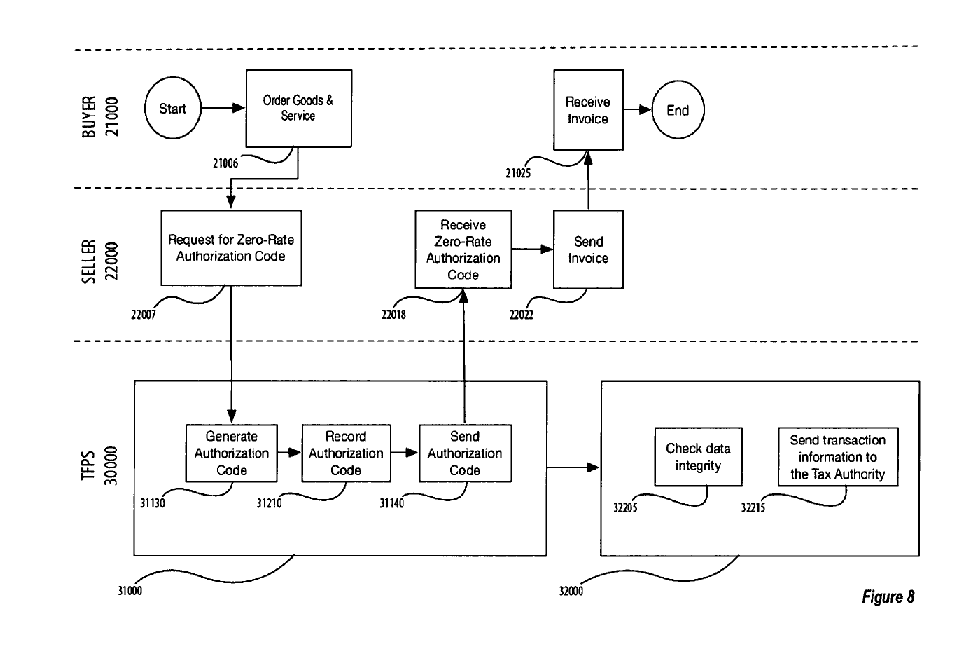

FIG. 8 Illustrates an Embodiment of the Process Flow of the Invention for B2B Sales Transactions where the Zero-Rate Tax Authorization does not Require Validation of the BIN.

In the preferred embodiment of this process flow, the BINS are not validated electronically and the Zero-Rate Tax Authorization Code is produced upon request.

In the preferred embodiment of this process flow, the system will interact with the TFPS Server [32000] to transfer the recorded data to the Tax Authority System [18000]. This interaction may or may not be in real-time or in periodic batch transfers using any secure communication link, using any method described in the prior art.

The process starts when:
the buyer places Order Goods & Services [21006];
the seller will Request for Zero-Rate Authorization Code [22007] from the BIAS [31100] of the TFPS Client [31000];
the BIAS [31100] will Generate Zero-Rate Authorization Code [31130];
the BIAS [31100] will Record Transaction Information [31210];
the BIAS [31100] will Send Zero-Rate Authorization Code [31140] to the seller;
the seller will Receive Zero-Rate Authorization Code [22018];
the seller will Send the Invoice [22022];
the buyer will Receive Invoice [21025];
End.

The risk in not authenticating the buyer is that a seller could erroneously or fraudulently identify the seller in a transaction. However, when the buyer is able to verify transactions recorded in the TFPS at Record Transaction Information [31210], then the buyer will able to accept or validate such transactions and when any transaction appears to be incorrect, the buyer can inform the tax authority and/or the seller of the error. While the correction might occur some time following the transaction, this can be deemed acceptable.

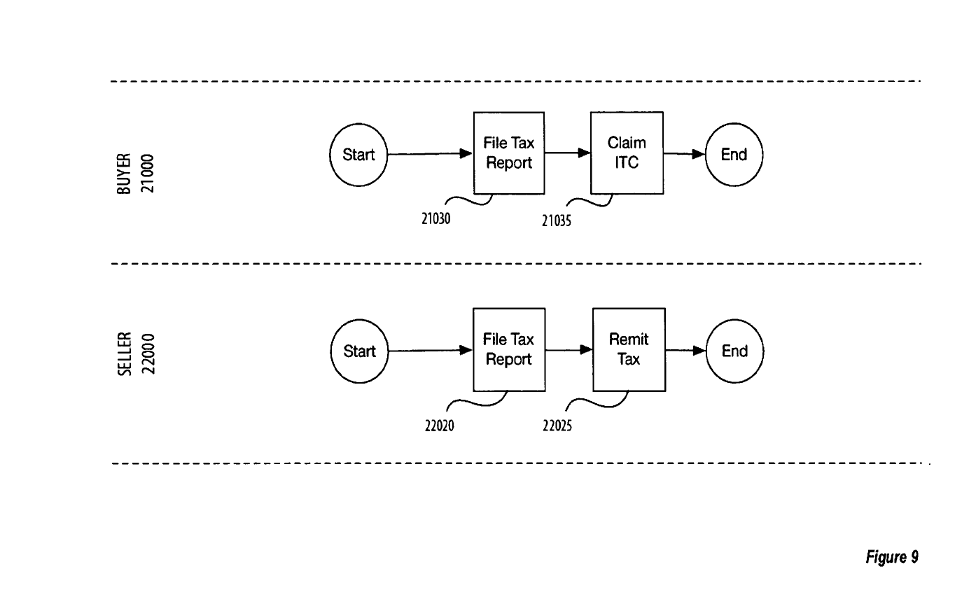

FIG. 9 Illustrates an Embodiment of the Tax Filing Process Flow after ITC has been Eliminated by the Use of the Invention.

In all embodiments, the invention can eliminate the need for the buyer and the seller to claim ITC, since all the sales and purchases between them would be authorized for zero-rate tax by the invention. This is the primary objective of the invention.

In all embodiments, the invention can provide the tax authority all the transactional information related to business sales and purchasing activities. Therefore the tax declaration process can be significantly simplified for B2B activities. This is the secondary objective of the invention.

The process starts when:
the seller will periodically File Tax Report [22020] and remit the owed amounts;
the seller will not Claim Input Tax Credit (ITC) [22025] as it would in the prior art as illustrated in FIG. 4;
the buyer will periodically File Tax Report [21030] and remit the owed amounts;
the buyer will not Claim Input Tax Credit (ITC) [21035] as it would in the prior art as illustrated in FIG. 4;
End.

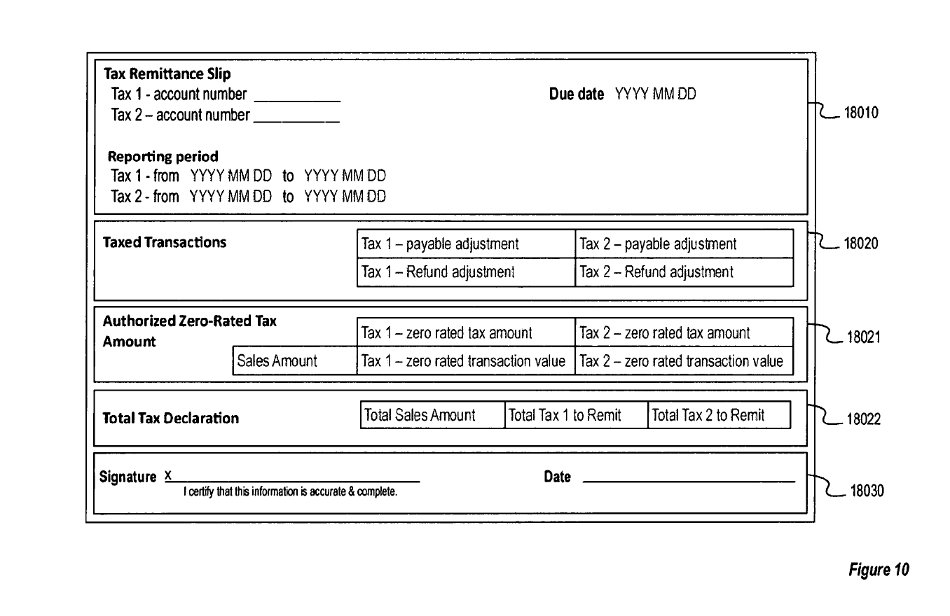

FIG. 10 Illustrates a Possible Example of a Periodic Sales Tax Declaration Form that could be Used within a Tax Jurisdiction that is Using Certain Embodiments of the Invention.

In all embodiments, the invention may render tax declaration unnecessary for all businesses that are strictly conducting B2B activities. In case the tax authorities decide otherwise, the invention may cause a tax authority to alter its current sales tax declaration form in order to collect some of, but not necessarily all, the information as per the following example:
The section Tax Remittance Slip [18010] is to identify the business along with the due date and reporting periods for one or more sales taxes. The two tax account numbers shown is an example where multiple tax accounts can be associated with a business, such as state and federal tax accounts in the case that remittance is consolidated with one agency. It will be appreciated that it is more typical to have a single tax account for a single jurisdiction.
The section Taxed Transactions [18020] is to report the total of taxes collected on sales and the taxes paid on purchases. This will enable the business to claim or remit tax amounts for transactions that were not authorized for Zero-Rated Tax.
The section Authorized Zero-Rated Tax Sales Amount [18021] is to report the total sales amounts that are authorized for zero-rated tax and the total of purchases made that were zero-rated. This is filled in using data stored in the TFPS, and would normally be received prepopulated. The importance of having these amounts on the declaration form is to ensure that the business confirms that these amounts correspond with what the business accounting system reports.
The section Total Tax Declaration [18022] is to report the difference between the taxes collected and taxes paid. This will produce either negative (remittance) or positive (ITC claim) figures that the company will declare.
The section [18030] is where the authorized signing officer of the business confirms and certifies that the declared information is accurate and complete.

It will be appreciated that the business making a tax declaration as exemplified in FIG. 10 can be assuming a responsibility under tax law and is liable if the declaration can be shown to be false.

Therefore, the business needs to verify and validate the zero-rated tax transactions identified in box [18020]. With reference to FIG. 2, this involves synchronizing or otherwise retrieving the transaction data from the TLS [32200] so that transactions recorded in the TFPS server [32000] can be verified. When the business' accounting software is fully configured for such a purpose, this can involve an automated comparison of the data between the business accounting system and the TFPS data.

When no such configuration is available, the business can simply compare the list of transactions from the TFPS server with what account data is found in the business accounting system. For example, if a customer or supplier name is found in the TFPS data that is not found on the list of customers or suppliers in the business' accounting system, then immediately a flag is raised.

A more detailed audit would involve confirming sales and expense amounts with respect to customers and suppliers. An even more detailed audit would involve confirming the description of goods or services related to the transaction, when such data is stored in the TFPS server. Preferably, a verification or audit of the TFPS server data is performed by the business prior to signing the declaration shown in FIG. 10.

FIG. 11 Illustrates an Embodiment of the Invention for B2B Sales Transactions where the Buyer can Confirm the Ownership of a Transaction or Report Errors, Using the TFPS, as Recorded by the Tax Authority.

In the case that the seller has initiated a transaction without the buyer's participation, the transaction will be marked as requiring attention from the buyer. At a later time, after the transaction has occurred the buyer can confirm ownership of the transaction.

The transaction ownership confirmation, which is illustrated in the FIG. 11, can be executed by any of the following;
the buyer;
the financial system of the buyer, with or without human intervention;

in an alternate embodiment, if the transaction is marked as requiring attention from the seller to confirm ownership of a transaction,
the seller;
the financial system of the seller, with or without human intervention.

This process will achieve one of the secondary objectives of the invention, to let businesses validate the authenticity of all their B2B transactions.

The process starts when:
the buyer Request Transaction Information (RTI) [21062] from the TFPS Client [31000];
the TFPS Client [31000] receive RTI [31301] and verify local database [31305] for data availability;

The requested transaction information can contain all or any part of the stored information related to that transaction.

If the information is not available [31310] in the local database then:
the TFPS Client [31000] will Send RTI [31315] to the TFPS Server [32000];
the TFPS Server [32000] will Forward RTI [32305] to the Tax Authority [18000];
the Tax Authority [18000] will Receive RTI [28060] and Retrieve Transaction Information [28062];
the Tax Authority [18000] will Send Transaction Information [28064] to the TFPS Server [32000];
the TFPS Server [32000] will Forward Transaction Information [32310] to the TFPS Client [31000];
the TFPS Client [31000] will Receive Transaction Information [31320];

when the information is available [31310] in the local database then:
the TFPS Client [31000] will Send Transaction Information [31325] to the Buyer.
the Buyer will Receive Transaction Information [21064];
the Buyer will Confirm Transaction Ownership [21066];
the Buyer will Send Information [21068] to the TFPS Client [31000];
If the confirmation is positive [31165]:
   the process ends;
when the confirmation is negative [31165]:
   the TFPS Client [31000] will Forward information [31166] to the TFPS Server [32000];
   the TFPS Server [32000] will Forward Information [32166] to the Tax Authority [18000];
   the Tax Authority [18000] will Receive Information [28066];
End.

1. A tax compliance system for use within a taxation system in which business-to-consumer transactions require a seller to collect sales tax and business-to-business transactions can be tax neutral, the system comprising:
a first subsystem configured to collect transaction data representing a transaction between a buyer and a seller of goods or services;
a second subsystem configured to receive input from said buyer to confirm an eligibility for a tax neutral business to business transaction with said seller concluding said transaction with no tax collection, wherein the eligibility for the tax neutral business to business transaction is determined by either one or both of:
a processor configured to authenticate a tax authority recognized identification certificate of said buyer as received from said buyer to ensure genuine involvement of said buyer in said transaction and to confirm that said buyer is genuinely a business and not a consumer; and
a processor configured to deliver, over a communication link to an electronic account associated with said buyer according to tax authority records, information concerning said transaction, and to receive from said buyer an indication if said transaction is not an actual transaction between said buyer from said seller;
a third subsystem configured to receive data from said second subsystem and, in response thereto, to provide for said seller either one or both of:
a tax exemption authorization message for the purposes of providing authorization for said transaction to take place without tax collection; and
a message or a report to inform said seller whether said transaction requires tax collection.

2. The system as defined in claim 1, wherein said transaction is performed electronically between said buyer and said seller using an electronic sales transaction system.

3. The system as defined in claim 2, wherein an identity of said buyer is confirmed using said tax authority recognized identification certificate of said buyer.

4. The system as defined in claim 2, wherein said seller is provided with said tax exemption authorization message for the purposes of providing authorization for said transaction to take place without tax collection.

5. The system as defined in claim 1, wherein said system comprises a server operative to:
authenticate said buyer;
receive said transaction data from said buyer; and
provide a confirmation that said transaction can proceed without tax collection.

6. The system as defined in claim 5, wherein said server is operative to authenticate said buyer through a business account login, and to receive from said buyer said transaction data through a web form for entering said transaction data for a single transaction.

7. The system as defined in claim 6, wherein said server generates a tax exemption authorization code for the purposes of providing authorization for said transaction to take place without tax collection.

8. The system as defined in claim 7, wherein said code is provided to said buyer for transmission to said seller independent of said server.

9. The system as defined in claim 8, wherein said server being further operative to provide said seller with confirmation that said code is valid.

10. The system as defined in claim 5, wherein said server is operative to allow said seller to validate said transaction, said validation causing said transaction to be defined as a confirmed transaction between said buyer and said seller.

11. The system as defined in claim 5, wherein said server is operable to authenticate said seller through a business account login.

12. The system as defined in claim 1, wherein said system comprises a server operative to:
authenticate said seller;
receive said transaction data from said seller identifying said buyer;
deliver, over a communication link to an electronic account associated with said buyer according to tax authority records, information concerning said transaction;
receive from said buyer an indication if said transaction is not an actual transaction between said buyer from said seller; and
provide at least said seller with a confirmation that said transaction can proceed without tax collection.

13. The system as defined in claim 12, wherein said server is operative to authenticate said buyer through a buyer account login, and to receive from said buyer said transaction data through a web form.

14. The system as defined in claim 1, wherein said system comprises a data store configured to store a record for each authorized said zero-rated tax transaction, with said record including the content of said transaction data, and said system is further configured to provide, for a predetermined audit period and for a predetermined business, a list of transactions involving said business, so as to allow an audit by said business to determine whether such transactions were in fact made by said business and whether said transaction qualifies as a zero-rated tax business-to-business transaction.

15. The system as defined in claim 14, wherein said system is configured to provide to registered businesses a statement of a sum of zero-rated tax business-to-business purchases or sales recorded in said data store for a predetermined tax reporting period, said statement for use in a tax compliance declaration by said registered businesses.

16. The system as defined in claim 15, wherein said statement comprises a sum of zero-rated tax business-to-business purchases and sales in said data store for a predetermined tax reporting period, said statement for use in a tax compliance declaration by said registered businesses.

17. The system as defined in claim 15, wherein said statement contains a reference or a link to access said data store to retrieve said list of transactions involving said business representing said sum.

18. The system as defined in claim 1, wherein said second subsystem is configured to store in an account of said buyer said tax authority recognized identification certificate of said buyer and confirms that said buyer is genuinely a business and not a consumer when a purchase is made using said account of said buyer.

19. The system as defined in claim 1, wherein said first subsystem is configured to detect that said buyer is located in a jurisdiction for which said seller is not required to collect sales tax, and said system comprises a data store configured to store a record for at least each said transaction in which said buyer is located in a jurisdiction for which said seller is not required to collect sales tax, said data store providing for said seller an auditable list of transactions with buyers presumed not subject to sales tax collection.

20. A data processing method in a tax compliance system for use within a taxation system in which business-to-consumer transactions require a seller to collect sales tax and business-to-business transactions can be tax neutral, the method comprising of:
collecting transaction data representing a transaction between a buyer and a seller of goods or services;
receiving input from said buyer to confirm an eligibility for a tax neutral business to business transaction with said seller concluding said transaction with no tax collection, wherein the eligibility for the tax neutral business to business transaction is determined by either one or both of:
authenticating a tax authority recognized identification certificate of said buyer as received from said buyer to ensure genuine involvement of said buyer in said transaction and to confirm that said buyer is genuinely a business and not a consumer; and
delivering, over a communication link to an electronic account associated with said buyer according to tax authority records, information concerning said transaction, and receiving from said buyer an indication if said transaction is not an actual transaction between said buyer from said seller;
providing to said seller either one or both of:
a tax exemption authorization message for the purposes of providing authorization for said transaction to take place without tax collection; and
a message or a report to inform said seller whether said transaction requires tax collection.
